(19) United States
(12) Patent Application Publication
(10) Pub. No.: US 2006/0212148 A1
(43) Pub. Date: Sep. 21, 2006

(54) Systems and methods for the evaluation of artistic performances

(75) Inventors: Mike Fitzgerald, Barrie (CA); Hans Hulan, Mount Albert (CA); Italo Noce, Tottenham (CA)

Correspondence Address: BERESKIN AND PARR, 40 KING STREET WEST, BOX 401, TORONTO, ON, M5H 3Y2, CA

(73) Assignee: Critech Enterprises Inc., Woodbridge (CA)

(21) Appl. No.: 11/082,948

(22) Filed: Mar. 18, 2005

(51) Int. Cl. G06F 17/00; H04R 29/00

(52) U.S. Cl. 700/94; 381/56

(57) ABSTRACT

Systems and methods for storing audio data correlated to at least one audio evaluation of at least one artistic performance. The system includes at least one audio input, and an audio database operatively coupled to each audio input. Each audio input is uniquely associated with a corresponding one of said at least one audio evaluation. As well, each audio input is configured to generate audio data correlated to the corresponding audio evaluation. The database is configured to receive and store audio data from said at least one audio input, and to store identifier data associated to said audio data, wherein said identifier data is correlated to said at least one artistic performance.

### FIELD OF THE INVENTION

The present invention relates generally to the field of artistic competitions, with common but by no means exclusive application to recording evaluations of artistic performances in such competitions. When used herein, the term “artistic performances” is typically intended to include performances of an artistic nature, including dancing and singing. However, it should be understood that performances which might not strictly be considered to be of an “artistic” nature, such as juggling or other feats of skill, for which an audible evaluation might reasonably be provided for feedback purposes, are also intended to be included within the scope of “artistic performances”.

### BACKGROUND OF THE INVENTION

Artistic competitions, such as for example, dance competitions, may involve numerous different segments, each of which in itself is a mini-competition. Typically, these segments may be divided up based on skill level, or nature of the performance (eg. jazz or tap dance). As a result, some competitions may involve large numbers of entries: hundreds of competitors may enter several different segments of a competition. Often, the competitors are students from different arts schools, studios or academies.

Each performance by a competitor is typically evaluated by a panel of judges who rank or otherwise score each performance. In addition, preferably, each judge will also critique or evaluate each performance, providing verbal commentary regarding both strengths and weaknesses warranting improvement. To date, such evaluations have been provided by the judge recording his or her verbal commentary onto cassette tapes using portable recorders. Each tape cassette must then be properly labeled and provided to the competitor (or the competitor's instructor, if appropriate). This is both costly since cassette tapes are not inexpensive and administratively time-consuming.

The applicants have accordingly recognized a need for systems and methods for more efficiently recording evaluations of artistic performances.

### SUMMARY OF THE INVENTION

In one aspect, the present invention is directed towards a method for storing audio data correlated to at least one audio evaluation of at least one artistic performance. The method includes the steps of:
(a) providing at least one audio input, each audio input uniquely associated with a corresponding one of said at least one audio evaluation;
(b) wherein each audio input is configured to generate audio data correlated to the corresponding audio evaluation;
(c) providing an audio database operatively coupled to each audio input;
(d) wherein said database is configured to receive and store audio data from each audio input;
(e) storing identifier data correlated to said at least one artistic performance in said audio database; and
(f) associating said identifier data to said audio data.

In another aspect, the present invention is directed towards a method for storing audio data correlated to a plurality of audio evaluations of at least one artistic performance. The method includes the steps of:
(a) providing a plurality of audio inputs, each audio input uniquely associated with a corresponding audio evaluation;
(b) wherein each audio input is configured to generate audio data correlated to the corresponding audio evaluation;
(c) providing an audio database operatively coupled to the audio inputs;
(d) wherein said database is configured to receive and store audio data from each audio input;
(e) storing identifier data correlated to said at least one artistic performance in said audio database; and
(f) associating said identifier data to said audio data.

A fee may be charged for providing the service of conducting the above-noted methods.

In yet another aspect, the present invention is directed towards a system for storing audio data correlated to at least one audio evaluation of at least one artistic performance. The system includes at least one audio input, and an audio database operatively coupled to each audio input. Each audio input is uniquely associated with a corresponding one of said at least one audio evaluation. As well, each audio input is configured to generate audio data correlated to the corresponding audio evaluation. The database is configured to receive and store audio data from said at least one audio input, and to store identifier data associated to said audio data, wherein said identifier data is correlated to said at least one artistic performance.

In another aspect, the present invention is directed towards a system for storing audio data correlated to at least one audio evaluation of at least one artistic performance. The system includes a plurality of audio inputs, and an audio database operatively coupled to the audio inputs. Each audio input is uniquely associated with a corresponding audio evaluation and each audio input is also configured to generate audio data correlated to the corresponding audio evaluation. The audio database is configured to receive and store audio data from each audio input and is also configured to store identifier data associated to said audio data, said identifier data being correlated to said at least one artistic performance.

In a further aspect, the invention is directed towards an evaluations database comprising a plurality of evaluations records, wherein each materials record comprises audio data correlated to an audio evaluation, and wherein each evaluation record further comprises identifier data, said identifier data being correlated to an artistic performance.

In yet another aspect, the invention is directed towards a system for storing audio data correlated to at least one audio evaluation of at least one artistic performance. The system includes a plurality of audio inputs, an enumeration module configured to detect the audio inputs, and a recording module operatively coupled to the audio inputs. Each audio input is uniquely associated with a corresponding audio evaluation, and each audio input is configured to generate audio data correlated to the corresponding audio evaluation. The recording module is configured to receive and store audio data from each audio input, and is also configured to store identifier data associated to said audio data, said identifier data being correlated to said at least one artistic performance.

### BRIEF DESCRIPTION OF THE DRAWINGS

The present invention will now be described, by way of example only, with reference to the following drawings, in which like reference numerals refer to like parts and in which:

FIG. 1 is a schematic diagram of an evaluation recording system made in accordance with the present invention.

FIG. 2 is a schematic diagram of example competition records data, as may be stored in a competitions database of the evaluation recording system of FIG. 1;

FIG. 3 is a schematic diagram of example performance type records data, as may be stored in a performance type database of the evaluation recording system of FIG. 1;

FIG. 4 is a schematic diagram of example performance subcategory records data, as may be stored in a performance subcategory database of the evaluation recording system of FIG. 1;

FIG. 5 is a schematic diagram of example entry records data, as may be stored in an entry database of the evaluation recording system of FIG. 1;

FIG. 6 is a flow diagram illustrating the steps of a method carried out by the evaluation recording system of FIG. 1, when the audio input devices are to be enumerated and designated;

FIG. 7 is a flow diagram illustrating the steps of a method carried out by the evaluation recording system of FIG. 1, when audio evaluation data is to be recorded;

FIG. 8 is a schematic diagram of example audio evaluation data records, and their file names, as may be stored in an evaluation database of the evaluation recording system of FIG. 1; and

FIG. 9 is a flow diagram illustrating the steps of a method carried out by the evaluation recording system of FIG. 1, when audio files are to be duplicated or transferred.

### DETAILED DESCRIPTION OF THE INVENTION

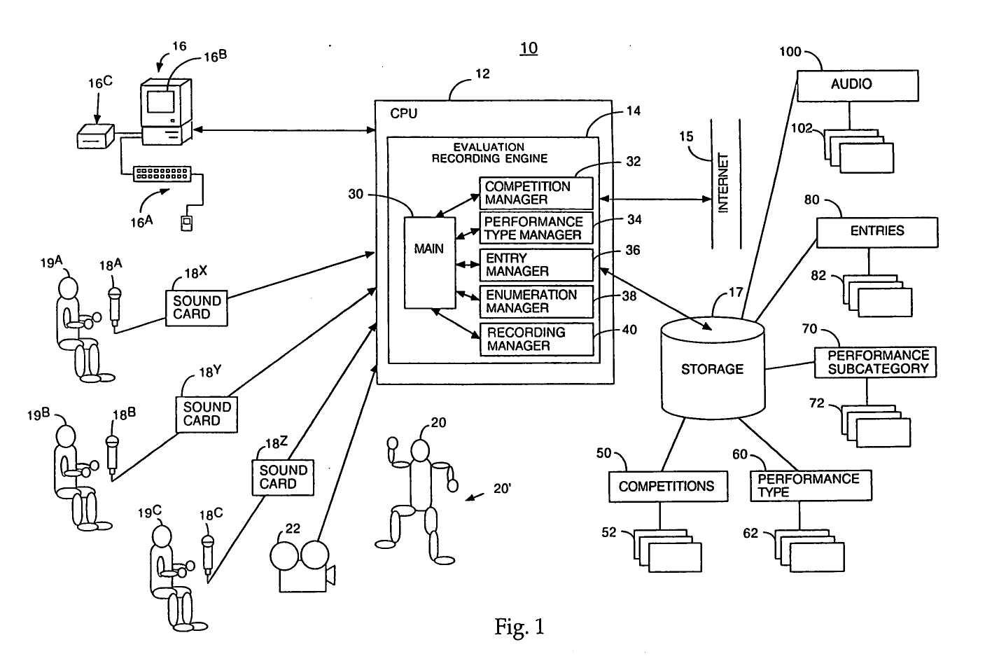

Referring to FIG. 1, illustrated therein is an evaluation recording system, referred to generally as 10, made in accordance with the present invention. The evaluation recording system 10 comprises a processor or central processing unit (CPU) 12 such as a standard personal computer (PC) running on a WINDOWS™ operating system and having a suitably programmed evaluation recording system engine 14. The CPU 12 may preferably be operatively coupled to the internet 15 or other data network for the exchange of data. An input/output device 16 (typically including an input component 16^{A} such as a keyboard, and output components such as a display 16^{B} and a CD ROM burner 16^{C}) is also operatively coupled to the CPU 12. Data storage 17 is also preferably provided—this data storage 17 may be local such as on a hard drive coupled to the CPU 12, or it may be remote networked data storage, as will be understood.

The evaluation recording system 10 also includes a plurality of audio input devices 18^{A}, 18^{B}, and 18^{C}, typically in the form of microphones. Each audio input device 18^{A}, 18^{B}, and 18^{C} is preferably provided with its own sound card 18^{X}, 18^{Y}, and 18^{Z}, typically coupled to the CPU 12 through standard USB (universal serial bus) ports. As will be understood, these microphones 18^{A}, 18^{B}, and 18^{C} are used to record spoken or audio critiques or evaluations by corresponding judges 19^{A}, 19^{B}, and 19^{C}. These evaluations are of each performer's 20 artistic performance 20′. The evaluation recording system may also include a video input 22 such as a video camera for recording video images and possibly sound of the performances.

The evaluation recording system engine 14 may include several modules. A main executable module 30 is preferably provided for controlling the operation of five sub-modules, which may be implemented as dynamic link libraries (dll) (which, as will be understood, may utilize existing libraries of functions in a WINDOWS™ operating environment): a competition manager 32, a performance type manager 34, an entry manager 36, and enumeration manager 38 and a recording manager 40. The main module 30 controls the interfacing between the user and each of the sub-modules 32, 34, 36, 38, 40.

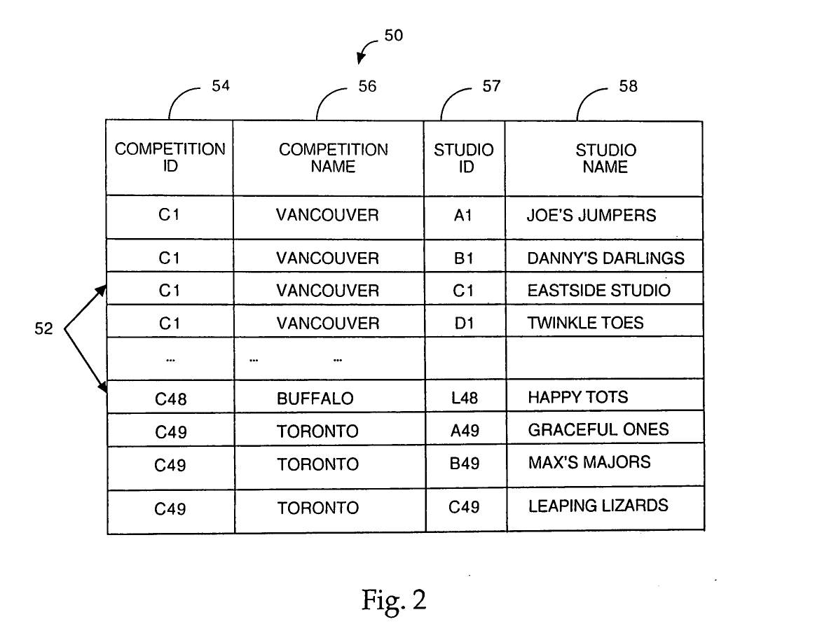

The competition manager 32 is configured to enable a user to input (or modify) and store data records 52 for new competitions (or showcases, if no winners are to be determined as a result of the judges' feedback) into a competitions database 50 stored in the data storage 17. Referring now to FIG. 2, illustrated therein is an example of the type of competition records 52 data typically stored in the competitions database 50. Typically the competition records 52 data will be determined and input into the database 60 by a competition organizer, when the parameters of a new competition or showcase have been determined.

Each competition record 52 will typically include unique competition identifier data 54, as well as data corresponding to the competition name 56 (often the name of the city in which the competition is to take place). The competition record 52 may also include a studio code 57 which is uniquely assigned to each studio 58 entering a particular competition. Typically, studio codes 57 are used to help keep a competitor's 20 studio confidential from the judges 19^{A}, 19^{B} and 19^{C}, to avoid the potential for favoritism or bias in the judging.

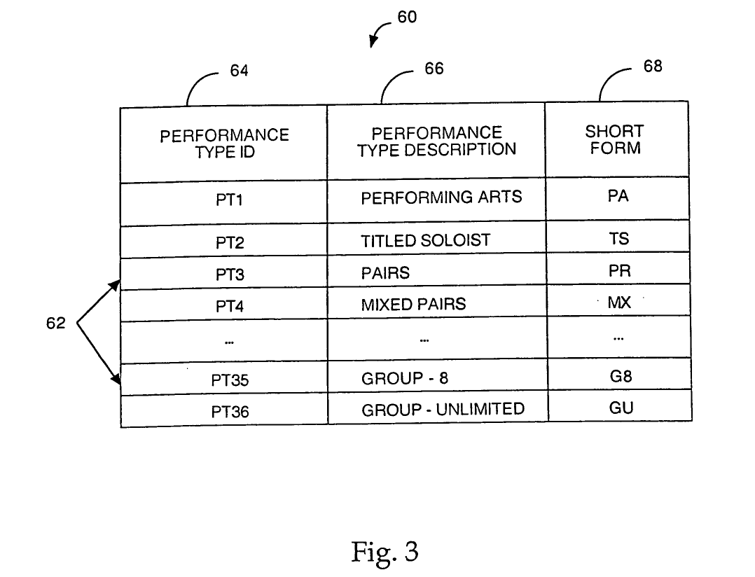

The performance type manager 34 is configured to enable a user to input (or modify) and store performance type data records 62 corresponding to types of performances into a performance type database 60 stored in the data storage 17. Referring now to FIG. 3, illustrated therein is an example of the type of performance type records 62 data typically stored in the performance type database 60. Typically the performance type record 62 data will be determined and input into the database 60 by a competition organizer, when the parameters of the competition (or showcase) have been determined.

Each performance type record 62 may include a unique performance type identifier 64, as well as data corresponding to the performance type description 66, together with data corresponding to a short-form performance type description 68.

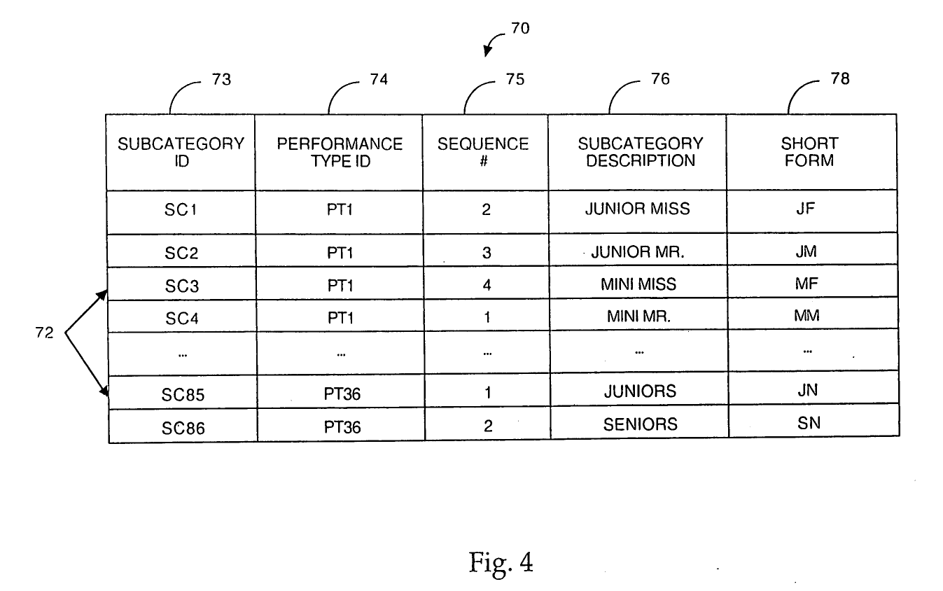

The performance type manager 34 may also be configured to enable a user to establish and store performance subcategory data records corresponding to types of performances into a performance subcategory database 70 stored in the data storage 17. Referring now to FIG. 4, illustrated therein is an example of the type of performance subcategory records 72 data typically stored in the performance subcategory database 70. Typically the performance subcategory record 72 data will be determined and input into the database 70 by a competition organizer, when the parameters of the competition (or showcase), together with the performance types 62, have been determined.

Each performance subcategory record 72 may include a performance type identifier 74 (corresponding to a performance type identifier 64 in, and effectively providing a link to, the performance type database 60, to which the performance subcategory 72 relates), as well as numerical sequence data corresponding to the order in which the subcategory 72 is to be sorted relative to the other subcategories 72 for the parent performance type 74, and data corresponding to the subcategory description 76, together with data corresponding to a short-form subcategory description 78.

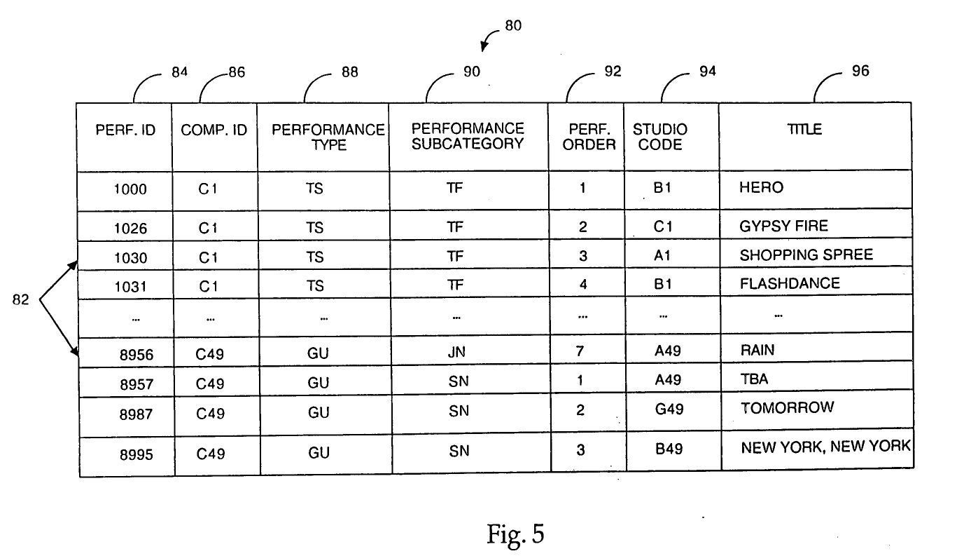

The entry manager 36 is configured to enable a user to input (and modify) and store entry data records corresponding to the various competitor 20 entries to specific competitions into an entry database 80 stored in the data storage 17. Referring now to FIG. 5, illustrated therein is an example of the type of entry records 82 data typically stored in the entry database 80. Typically the entry record 82 data will be determined and input into the database 80 by a competition organizer, when the entry registration forms are received from the competitors 20.

Each entry record 82 may include a unique entry or performance identifier 84, a competition identifier 86 (corresponding to a competition identifier 54 in, and effectively providing a link to, the competition database 50) identifying the competition in which the entry's 82 performance is to take place.

The entry record 82 may also include performance type data 88 (corresponding to a short-form performance type description 68 in, and effectively providing a link to, the performance type database 60). Performance subcategory data 90 may also be provided (corresponding to a short-form subcategory description 78 in, and effectively providing a link to, the performance subcategory database 70), identifying the subcategory (if any) in which the competitor (or team/group) 20 will be competing for that particular entry 82.

A performance order number 92 may be provided, which is unique to the performance type 88/subcategory 90 combination, and which reflects the order within the subcategory 90 (or performance type 88, if no such subcategory 90 exists) in which the competitor 20 will perform. The entry records 82 may also include studio code data 94 (corresponding to the studio codes 57 in the competition database 50), to identify the competitor's 20 studio. A field may also be provided in the entry record 82 to store the title 96 of the entry, such as the title of the music used in a dance performance.

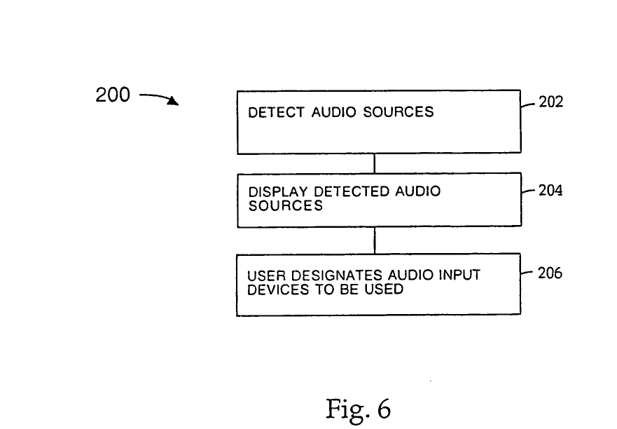

Referring now to FIG. 6, this figure is a flow chart setting out the process 200 carried out by the enumeration manager 38. Typically, at the start of a competition or showcase, a user will (via the main module 30) activate the enumeration manager 38. The enumeration manager 38 is configured to first scan the number of audio sources or sound cards operatively coupled to the CPU 12, and determine a Globally Unique Identifier (GUID) for each (Block 202). These audio sources will typically include any internal sound cards connected to the CPU 12, as well as each of the audio input devices 18^{A}, 18^{B}, and 18^{C} (specifically, each corresponding sound card 18^{X}, 18^{Y}, and 18^{Z}).

In a WINDOWS™ operating environment, typically this may be accomplished by importing enumeration methods from Microsoft.DirectX.DirectSound. As will be understood, DirectX™ contains a library of multimedia application programming interfaces (APIs) built into WINDOWS™ operating systems, providing software developers with access to specialized hardware features. DirectSound™ specifically provides applications with methods for playing and capturing sounds, typically from sound cards.

The enumeration manager 38 will then display on the monitor 16^{A} for the user's selection, all of the audio sources coupled to the CPU 12 (Block 204). The enumeration manager 38 is configured to enable the user to then designate all or some of the audio input devices 18^{A}, 18^{B}, and 18^{C} (for the purposes of this example, it is assumed that the built-in sound card will not be designated, but that the three input devices 18^{A}, 18^{B}, and 18^{C} are designated) for capturing and storing audio data (Block 206). For each designated audio input device 18^{A}, 18^{B}, and 18^{C}, the enumeration manager 38 stores (typically in the CPU's RAM) device information including description and device GUID (Block 208).

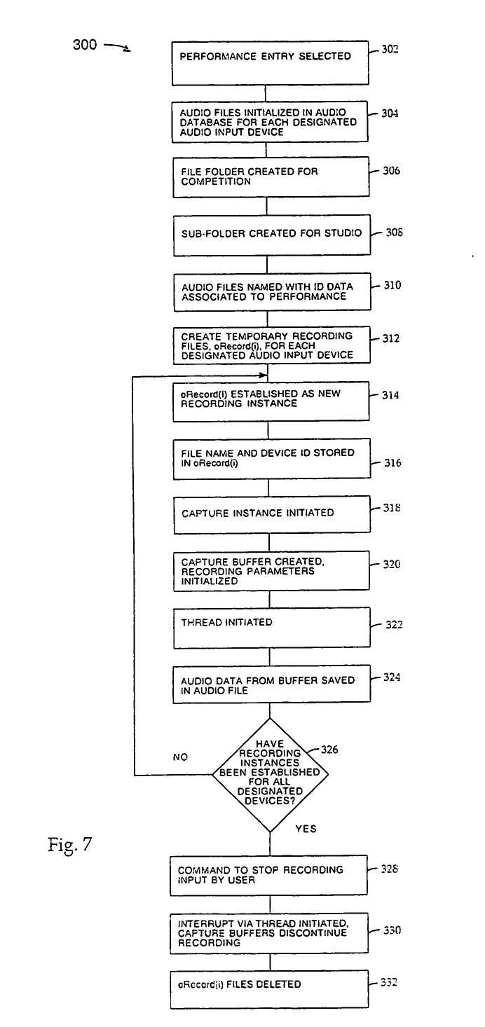

Referring now to FIG. 7, this figure is a flow chart setting out the process 300 carried out by system 10, when audio evaluation data is to be recorded. Typically, when a performance is about to begin, a user will (via the main module 30) first select an entry record 82 from the entry database 80, corresponding to the performance which is about to be performed by the competitor 20 and simultaneously evaluated by the judges 19^{A}, 19^{B}, and 19^{C} (Block 302).

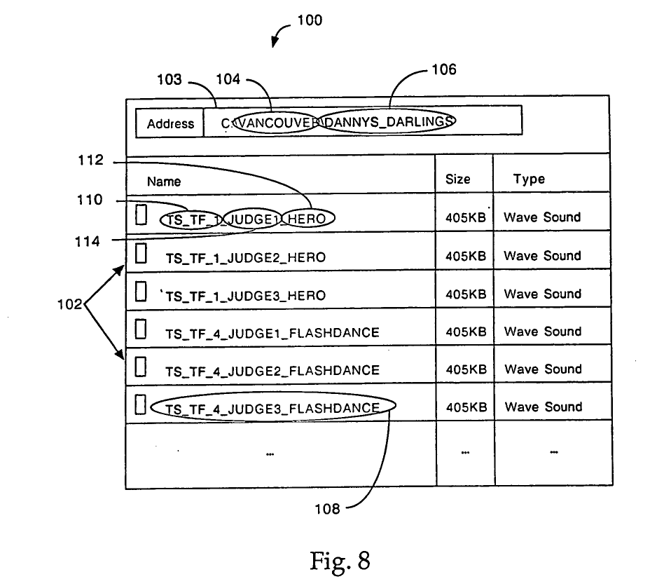

The recording manager 40 then creates and initializes an empty evaluation audio file for each of the designated audio input devices 18^{A}, 18^{B}, and 18^{C} in an audio database 100 stored in the data storage 17 (Block 302). Referring simultaneously to FIG. 8, illustrated therein is a sample screen display identifying example audio record file names corresponding to audio files 102 typically stored in the audio database 100, as may appear in a WINDOWS™ environment.

When creating the audio files, the recording manager 40 may first create a file folder within the data storage 17 and named based on the competition name 56 corresponding to the competition identifier 86 in the entry record 82 (Block 304). If such a folder already exists, the recording manager 40 will simply select the folder, rather than creating a new one.

The recording manager 40 may also create a sub-folder within the competition file folder. The sub-folder name is preferably selected to match the studio name 58 corresponding to the studio code data 94 in the entry record 82 (Block 306). Again, if such a sub-folder already exists, the recording manager 40 will simply select the sub-folder, rather than creating a new one. As will be understood, as an alternative to creating folders and subfolders with naming identifiers corresponding to the competition name and possibly the studio name, the audio data may be stored in an audio database having fields for storing data corresponding to the competition name and to any studio name, which may be indexed for locating and selecting audio files after recording.

As shown in FIG. 8, the pathnames 103 for the storage location in the data storage 17 where the audio files 102 are stored identifies the folder 104 (named for the competition 56) and the subfolder 106 (named for the studio 58). The recording manager 40 is also preferably programmed to create file names 108 for the audio files containing identifier data which further associate the audio files to the entry 82 performance, by including a name portion 110 corresponding to the performance order number 92 (and possibly also corresponding to the performance type 88 and performance subcategory 90), together with a name portion 112 corresponding to the title 94 of the entry (Block 308). The file names 108 will also preferably include a name portion 114 corresponding to the particular judge 19^{A}, 19^{B}, and 19^{C}.

For each designated designated audio input device 18^{A}, 18^{B}, and 18^{C}, the recording manager 40 is configured to create a temporary recording file, for example called oRecord(i) (where i represents the indexed device number) (Block 310).

The recording manager 40 then carries out the following steps for each temporary recording file, oRecord(i), corresponding to a designated device 18^{A}, 18^{B}, and 18^{C}. The temporary recording file oRecord(i) is established as a new recording instance (Block 312). The file name created and discussed in connection with Block 308 and the device GUID are saved as properties of oRecord(i) (Block 314). A capture instance is then initiated, which is associated with the temporary recording file oRecord(i) (Block 316).

A capture buffer is then created, and the recording quality parameters are initialized (Block 318). It has been found that the following recording quality parameters typically provide sufficient speaking voice recording quality: Number of Channels=1; Average Bytes Per Second=48000; Bits Per Sample=8; Samples Per Second=48000. Typically, in addition to the judges' verbal evaluations, the audio input devices 18^{A}, 18^{B}, and 18^{C} are preferably positioned to also detect and record any accompanying music or other sounds from the performance which will assist in synchronizing the judge's comments with the performance 20′, when such comments are replayed at a later date.

A thread is then initiated (Block 320), which can later be used to discontinue the capture buffer when recording is to be terminated. The buffer data is then saved in the audio file (Block 322). The audio file 102 is preferably saved as a WAVE file, which is a type of RIFF (Resource Interchange File Format) file specifically designed for multimedia data files. In addition to the audio data, WAVE files may also include data correlated to the length of the file, the number of channels and the sample rates.

The steps in Blocks 306-316 are then repeated for each of the remaining designated capture devices (Block 318). When the performance is over, the user will (via the main module 30) input a command that the recording is to stop (Block 320). The recording manager 40 will then effectively generate an interrupt via the thread initiated in Block 314 which will cause each of the capture buffers for the designated audio sources to discontinue recording (Block 322).

The temporary recording files are then deleted (Block 332).

The recording process (Blocks 302-332) may then be repeated for the other entries 82 in the entry database 80.

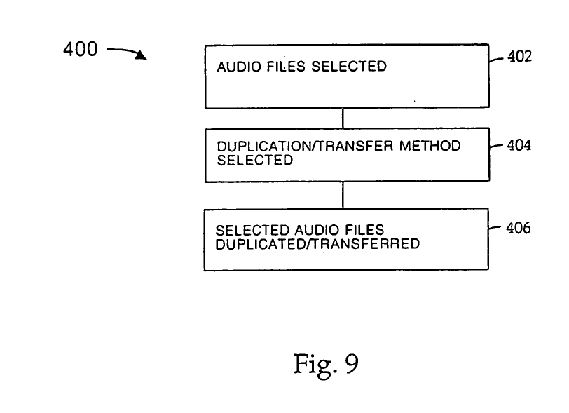

Referring now to FIG. 9, this figure is a flow chart setting out the process 400 carried out by system 10 once some or all of the audio files 102 have been recorded and stored for a competition. Via the main module 30, the user may select certain audio files 102 for duplication and/or transfer to a competitor 20 or other party (for example, the competitor's teacher) (Block 402).

The user may also select the method of duplication and/or transfer (Block 404). For example, the selected audio files 102 may be copied onto portable storage media such as a recordable CD-ROM, using the CD-ROM burner 16^{C}. Other hardware in place of a CD-ROM burner 16^{C}, may be provided, enabling duplication of the audio files onto computer discs or other magnetic recording media such as cassette tapes, or non-volatile memory cards such as flash media cards. Additionally, the main module 30 may be configured to allow the user to email the audio files to the recipient via the internet 15, or to upload the audio files 102 to a server coupled to the internet 15 or other communications network for future retrieval by the competitor 20 or other authorized individual via the internet 15. Once the method of duplication and/or transfer of the audio files has been determined by the user, the main module 30 is configured to carry out such transfer/duplication (Block 406).

The system 10 has been illustrated and described as recording audio data corresponding to judges evaluations, in addition to the sounds of the performances, themselves. Alternatively, or in addition to such audio data, as noted, the system 10 may be provided with a video input 22, which may be used to store video and possibly audio data of the performances in a video data base in the data storage 17, as well.

While the system 10 has been illustrated and described as utilizing three audio input devices 18^{A}, 18^{B}, and 18^{C} it should be understood that larger or smaller numbers of input devices may be used. In general, the number of audio input devices utilized by the system 10 will be limited by the processing power of the CPU 12 and the designated sound recording quality.

Thus, while what is shown and described herein constitute preferred embodiments of the subject invention, it should be understood that various changes can be made without departing from the subject invention, the scope of which is defined in the appended claims.

1. A method for storing audio data correlated to at least one audio evaluation of at least one artistic performance, said method comprising the steps of:
(a) providing at least one audio input, each audio input uniquely associated with a corresponding one of said at least one audio evaluation;
(b) wherein each audio input is configured to generate audio data correlated to the corresponding audio evaluation;
(c) providing an audio database operatively coupled to each audio input;
(d) wherein said database is configured to receive and store audio data from each audio input;
(e) storing identifier data correlated to said at least one artistic performance in said audio database; and
(f) associating said identifier data to said audio data.

2. A method for storing audio data correlated to a plurality of audio evaluations of at least one artistic performance, said method comprising the steps of:
(a) providing a plurality of audio inputs, each audio input uniquely associated with a corresponding audio evaluation;
(b) wherein each audio input is configured to generate audio data correlated to the corresponding audio evaluation;
(c) providing an audio database operatively coupled to the audio inputs;
(d) wherein said audio database is configured to receive and store audio data from each audio input;
(e) storing identifier data correlated to said at least one artistic performance in said audio database; and
(f) associating said identifier data to said audio data.

3. The method as claimed in claim 2, further comprising selecting certain audio data stored in said audio database, and copying said selected audio data onto portable storage media.

4. The method as claimed in claim 3, wherein said portable storage media comprises one selected from the group consisting of CD-ROM, magnetic tape, and memory card.

5. The method as claimed in claim 2, further comprising selecting certain audio data stored in said audio database and transmitting said selected audio data via a communications network.

6. The method as claimed in claim 2, further comprising the steps of:
(a) providing a video input;
(b) providing a video database operatively coupled to the video input; and
(c) wherein said video database is configured to receive and store video data from the video input, said video data corresponding to said performance.

7. A computer readable medium storing program code, which when executed on a computer, causes the computer to perform the method of claim 2.

8. A method of doing business, comprising the step of charging a fee for conducting the steps of the method of claim 2.

9. A method of doing business, comprising the step of selling the portable storage media of claim 3.

10. A system for storing audio data correlated to at least one audio evaluation of at least one artistic performance, the system comprising:
(a) at least one audio input, each audio input uniquely associated with a corresponding one of said at least one audio evaluation;
(b) wherein each audio input is configured to generate audio data correlated to the corresponding audio evaluation;
(c) an audio database operatively coupled to each audio input;
(d) wherein said database is configured to receive and store audio data from said at least one audio input;
(e) wherein said database is further configured to store identifier data associated to said audio data, wherein said identifier data is correlated to said at least one artistic performance.

11. The system as claimed in claim 10, wherein said identifier data is stored in a file name corresponding to said audio data.

12. A system for storing audio data correlated to at least one audio evaluation of at least one artistic performance, the system comprising:
(a) a plurality of audio inputs, each audio input uniquely associated with a corresponding audio evaluation;
(b) wherein each audio input is configured to generate audio data correlated to the corresponding audio evaluation;
(c) an audio database operatively coupled to the audio inputs;
(d) wherein said database is configured to receive and store audio data from each audio input;
(e) wherein said database is further configured for storing identifier data associated to said audio data, said identifier data being correlated to said at least one artistic performance.

13. The system as claimed in claim 12, wherein at least one audio input comprises a microphone.

14. The system as claimed in claim 12, wherein at least one audio input comprises a sound card.

15. A system for storing audio data correlated to at least one audio evaluation of at least one artistic performance, the system comprising:
(a) a plurality of audio inputs, each audio input uniquely associated with a corresponding audio evaluation;
(b) wherein each audio input is configured to generate audio data correlated to the corresponding audio evaluation;
(c) an enumeration module configured to detect the audio inputs;
(d) a recording module operatively coupled to the audio inputs;
(e) wherein said recording module is configured to receive and store audio data from each audio input;
wherein said recording module is further configured to store identifier data associated to said audio data, said identifier data being correlated to said at least one artistic performance.

16. The system as claimed in claim 15, wherein at least one audio input comprises a microphone.

17. The system as claimed in claim 15, wherein at least one audio input comprises a sound card.

18. An audio database comprising a plurality of audio files, wherein each audio file comprises audio data correlated to an audio evaluation, and wherein each audio file further comprises identifier data, said identifier data being correlated to an artistic performance.

19. An audio database as claimed in claim 18, wherein each audio file comprises a file name, and wherein said file name comprises said identifier data.
